(19) United States
(12) Patent Application Publication
(10) Pub. No.: US 2020/0064523 A1
(43) Pub. Date: Feb. 27, 2020

(54) METASURFACE OPTICAL SYSTEMS AND METHODS

(71) Applicant: Intel Corporation, Santa Clara, CA (US)

(72) Inventors: Prashant Majhi, San Jose, CA (US); Kunjal Parikh, Fremont, CA (US); Paul West, Hillsboro, OR (US)

(73) Assignee: Intel Corporation, Santa Clara, CA (US)

(21) Appl. No.: 16/669,775

(22) Filed: Oct. 31, 2019

(51) Int. Cl. G02B 3/02

(52) U.S. Cl. CPC G02B 3/02; G02B 2003/0093

(57) ABSTRACT

The present disclosure is directed to systems and methods useful for providing a metasurface lens formed by a plurality of multi-piece optical structures disposed on, about, or across at least a portion of the surface of substrate member. Each of the plurality of multi-piece optical structures includes a solid cylindrical core structure surrounded by a hollow cylindrical core structure such that a gap having a defined width forms between the solid cylindrical core structure and the hollow cylindrical structure surrounding the solid core. The width of the gap determines the optical performance of the metasurface lens. The multi-component optical structures forming the metasurface lens advantageously produce little or no phase shift in the electromagnetic energy passing through the metasurface lens, thereby beneficially providing an optical device having minimal or no dispersion and/or chromatic aberration.

### TECHNICAL FIELD

The present disclosure relates to systems and methods for producing optical lenses, more specifically metasurface lenses that minimize the effect of through-the-lens dispersion.

### BACKGROUND

Typical optical systems rely on relatively heavy and relatively large refractive and diffractive optics. Compound lens designs that combine relatively thick curved lens combinations (e.g., convex, plano-convex, concave, and plano-concave lenses) that minimize chromatic dispersion of the light passing through the lens. Such compound lenses may be manufactured by grinding and polishing different types of relatively thick glass (SiO₂) elements that are arranged in combinations that reduce dispersion (e.g., “achromatic doublet”). Such conventional compound lens designs are relatively thick, and are limited by surface preparation (e.g., grinding) and polishing techniques. Such conventional compound lenses are also relatively expensive, and heavy. For example, a high quality camera lens may cost several thousand dollars and weigh over 10 pounds. The complexity, cost, and weight of such compound lenses is primarily associated with the reduction of chromatic aberration within the lens. Thus, a significant benefit may be realized through the use of thinner and/or lighter optical systems. Current thin lens systems often has significant phase shift based on the wavelength of the incident electromagnetic energy (commonly referred to as “dispersion”), thereby causing different visible wavelengths to focus on different focal planes.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram that depicts an illustrative optical system that includes a lens formed by the deposition of a metasurface layer disposed on a substrate to provide a relatively lightweight, relatively compact, and dispersion-free optical system when compared to conventional lens-based optics, in accordance with at least one embodiment described herein;

FIG. 2 is a perspective view of a portion of an illustrative lens that includes a plurality of cylindrical optical structures disposed on a surface of a substrate, in accordance with at least one embodiment described herein;

FIG. 3 is a schematic diagram that compares the performance of a metasurface lens formed using a plurality of single, uniform, optical structures and a metasurface lens in accordance with the apparatuses and systems described herein that is formed using a plurality of multi-component optical structures, in accordance with at least one embodiment described herein.

FIG. 4A is a cross-sectional elevation of a system that includes an illustrative optical structure layer disposed proximate at least a portion of the upper surface of a substrate member, in accordance with at least one embodiment described herein;

FIG. 4B is a cross-sectional elevation of the system after deposition of an etch mask on, about, or across at least a portion of the upper surface of the optical structure layer, in accordance with at least one embodiment described herein;

FIG. 4C provides a cross-sectional elevation of the system after etching to provide voids the optical structure layer, in accordance with at least one embodiment described herein;

FIG. 4D provides a cross-sectional elevation of the system after removal of the etch mask to provide the plurality of multi-element optical structures disposed across at least a portion of the upper surface of the substrate member, in accordance with at least one embodiment described herein;

FIG. 5 is a schematic diagram of an illustrative electronic, processor-based, device having one or more physical input devices including a metasurface image acquisition device, in accordance with at least one embodiment described herein; and

FIG. 6 is a logic flow diagram of an illustrative high-level method for producing a metasurface lens that includes a plurality of multi-component optical structures, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

Metasurfaces have shown great promise to revolutionize optical system by replacing relatively thick and heavy lenses with relatively thin, flat, and light lenses. Current metasurfaces provide a strong and precise control of light passing through the structure. However, the phase shift imposed by such metasurfaces is wavelength dependent (commonly referred to as “dispersion”). For example, metasurface lenses tend to focus red light at a different focal plane than blue light. Such dispersion is undesirable for broadband imaging applications, such as cameras.

The systems and methods described herein beneficially provide a relatively thin and flat optical lens composed of structures formed using one or more transparent materials having a relatively high refractive index, such as TiO₂. The systems and methods disclosed herein include a plurality of individual structures, such as posts, formed in concentric layers that provide a defined phase shift and minimal dispersion across all or a portion of the visible electromagnetic spectrum. Such lenses may be designed to provide any desired focal length while reducing or even eliminating chromatic dispersion.

An optical system is provided. The optical system may include: a substrate having a first surface, a thickness, and a second surface disposed transversely across the substrate thickness from the first surface; a plurality of optical structures disposed across at least a portion of the first surface of the substrate, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

A metasurface optics manufacturing method is provided. The method may include: depositing an optical structure layer having a first thickness across at least a portion of a surface of a substrate layer; patterning an etch mask on the surface of the optical structure layer; and etching the optical structure layer to provide a plurality of optical structures, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

A metasurface optics manufacturing system is provided. The system may include: means for depositing an optical structure layer having a first thickness across at least a portion of a surface of a substrate layer; means for patterning an etch mask on the surface of the optical structure layer; and means for etching the optical structure layer to provide a plurality of optical structures, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

An electronic device is provided. The electronic device may include: processor circuitry; system memory circuitry; one or more I/O device circuits, including: an optical system, that includes: a substrate having a first surface, a thickness, and a second surface disposed transversely across the substrate thickness from the first surface; a plurality of optical structures disposed across at least a portion of the first surface of the substrate, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

As used herein, the term “visible electromagnetic spectrum” includes all or a portion of the human visible electromagnetic spectrum that extends from 360 nanometers (nm) wavelength to 790 nm wavelength.

As used herein, materials referred to as “transparent” transmit all or a portion of the incident electromagnetic energy. For example, a material referred to as being “transparent to at least a portion of the visible electromagnetic spectrum” refers to a material that transmits at least a portion of the incident electromagnetic energy having wavelengths between 360 nm and 790 nm. Such materials may or may not pass electromagnetic energy in other portions (e.g., ultraviolet, infrared) of the electromagnetic spectrum.

As used herein, the term “on-chip” or elements, components, systems, circuitry, or devices referred to as “on-chip” include such items integrally fabricated with the processor circuitry (e.g., a central processing unit, or CPU, in which the “on-chip” components are included, integrally formed, and/or provided by CPU circuitry) or included as separate components formed as a portion of a multi-chip module (MCM) or system-on-chip (SoC).

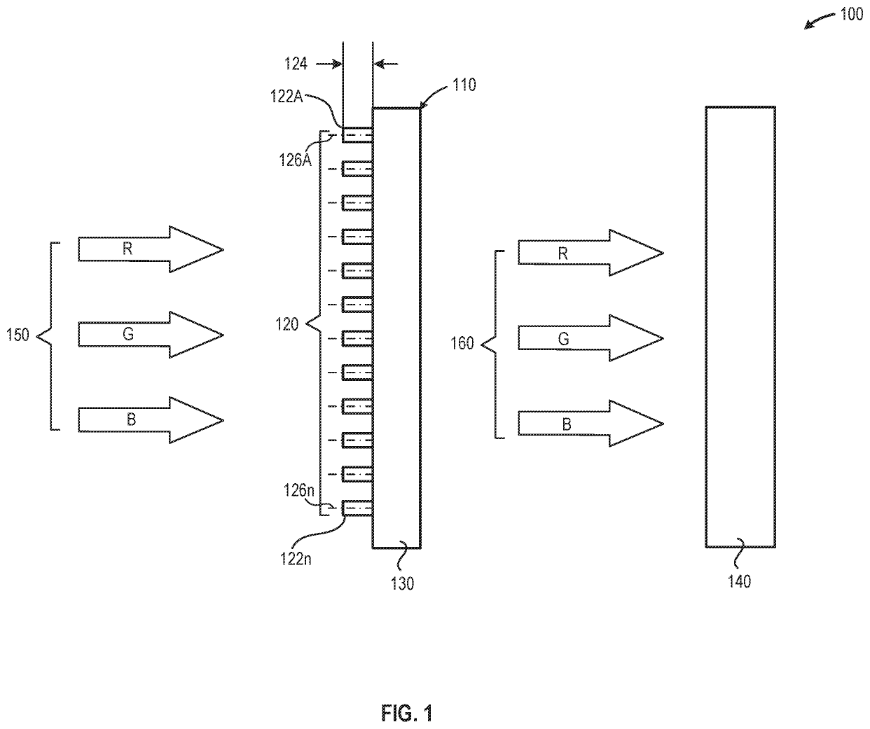

FIG. 1 is a schematic diagram that depicts an illustrative optical system 100 that includes a lens 110 formed by the deposition of a metasurface layer 120 disposed on a substrate 130 to provide a relatively lightweight, relatively compact, and dispersion-free optical system when compared to conventional lens-based optics, in accordance with at least one embodiment described herein. As depicted in FIG. 1, incoming incident electromagnetic energy 140 having an incident phase relationship passes through the metasurface structure 120 and the substrate 130 while maintaining the incident phase relationship of the incident electromagnetic energy spectra. In embodiments, after passing through the lens 110 the electromagnetic energy 150 may fall incident at a focal point of an image acquisition device 130 such as a CMOS or CCD image acquisition device disposed in a still or video camera.

The lens 110 includes a metasurface layer 120 disposed on, about, or across at least a portion of a substrate 130. In embodiments, the metasurface layer 120 may include a plurality of multi-piece optical structures 122A-122n (collectively, “multi-piece optical structures 122”) disposed on, about, or across at least a portion of the substrate 130. Each of the multi-piece optical structures 122 includes a plurality of structures, for example a solid inner optical structure that is at least partially surrounded by a hollow outer optical structure disposed concentrically about the solid inner optical structure to provide a consistent gap, void, or space between the solid inner optical structure and the hollow outer optical structure. In at least one embodiment, the solid inner optical structure may include a solid cylindrical inner core member at least partially surrounded by a hollow cylindrical member disposed concentrically about the solid cylindrical inner core member.

In embodiments, each of the multi-piece optical structures 122A-122n includes a respective longitudinal axis 126A-126n (collectively, “longitudinal axes 126”). In embodiments, the longitudinal axis 126 of each of the multi-piece optical structures 122 may be disposed at any angle with respect to the surface of the substrate member 130. In embodiments, the longitudinal axis 126 of each of the multi-piece optical structures 122 may be parallel to each of the remaining longitudinal axes of the remaining multi-piece optical structures 122 In embodiments, the longitudinal axis 126 of each of the multi-piece optical structures 122 may be disposed normal to (i.e., forming a 90° angle with respect to) the surface of the substrate member 130.

The metasurface layer 120 includes a plurality of multi-piece optical structures 122 formed using one or more relatively high refractive index dielectric materials or combination of materials, such as Titanium Dioxide (TiO₂) or Zirconium Dioxide (ZrO₂). In embodiments, the multi-piece optical structures 120 may be formed using one or more materials having a refractive index of: greater than about 1.5; greater than about 1.7; greater than about 1.9; greater than about 2.1; greater than about 2.3; greater than about 2.5; or greater than about 2.7. In embodiments, each of the plurality of multi-piece optical structures 120 may have the same or different heights measured from the surface of the substrate 130. In embodiments, each of the plurality of multi-piece optical structures 122 may have a height measured from the surface of the substrate 130 of about: 0.5 micrometers (μm) or less; 0.7 μm or less; 0.9 μm or less; 1 μm or less; 1.2 μm or less; 1.5 μm or less; or 2.0 μm or less. For example, in one or more embodiments, each of the plurality of multi-piece optical structures 122 may have a similar height of approximately 1 μm measured from the surface of the substrate 130.

The substrate 130 may include any material or combination of materials transparent to all or a portion of the visible electromagnetic spectrum. In embodiments, the substrate 130 may include a member having one or more planar surfaces, a member having one or more convex surfaces, a member having one or more concave surfaces, or any combination thereof (biconvex member, plano-convex member, positive meniscus member, negative meniscus member, plano-concave member, biconcave member, etc.). The substrate 130 may include any material or combination of materials that causes minimal or no phase shift in all or a portion of the electromagnetic energy 160 that passes through the lens 110. In embodiments, the substrate 130 may be formed using Silicon Dioxide (SiO₂) or Aluminum Oxide (Al₂O₃).

The image acquisition device 140 may include any number and/or combination of currently available and/or future developed electronic components, optical components, semiconductor devices, or logic elements capable of generating an output signal that includes information and/or data representative of an image acquired by electromagnetic energy passing through the lens 110. In embodiments, the image acquisition device 140 may include one or more charge-coupled device (CCD) sensors or one or more complementary metal oxide semiconductor (CMOS) sensors. The image acquisition device 140 may have any resolution. For example, the image acquisition device 140 may include an image sensor having a resolution of: greater than about 1 megapixel (MP); greater than about 5 MP; greater than about 10 MP; greater than about 20 MP; or greater than about 30 MP.

The incident electromagnetic energy 150 includes at least electromagnetic energy within the visible electromagnetic spectrum. In embodiments, the incident electromagnetic energy 150 may include electromagnetic energy in the ultraviolet (UV) electromagnetic spectrum and/or the infrared (IR) electromagnetic spectrum. In embodiments, at least a portion of the incident electromagnetic spectrum may include electromagnetic energy having a plurality of wavelengths having a defined phase relationship. Beneficially, the lens 110 minimizes or even eliminates chromatic aberration since the electromagnetic energy 160 departing the lens 110 retains the phase relationship between the constituent elements of the incident electromagnetic energy 150.

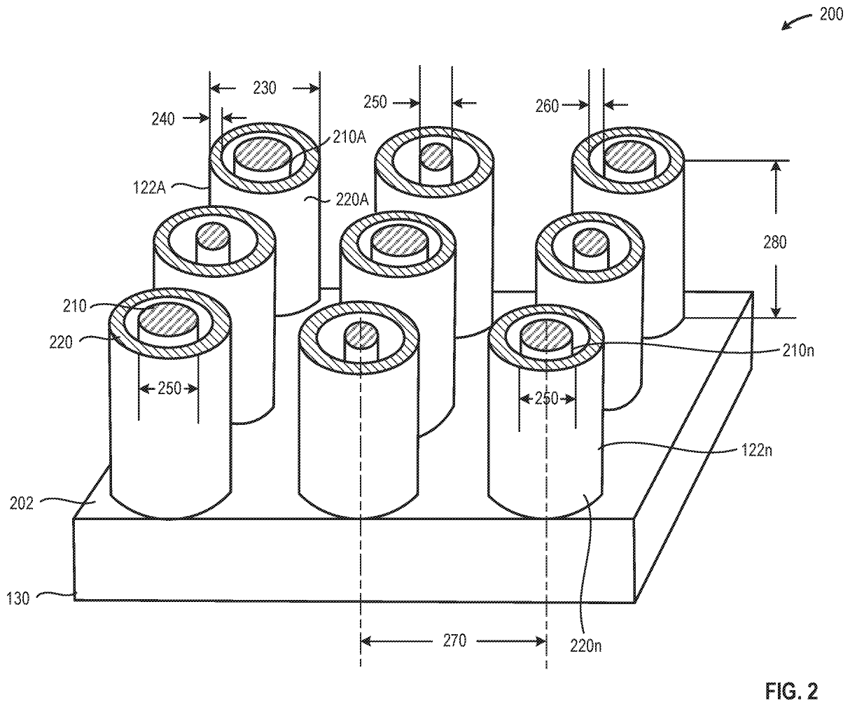

FIG. 2 is a perspective view of a portion of an illustrative lens 110 that includes a plurality of cylindrical multi-piece optical structures 122A-122n disposed on a surface 202 of a substrate 130, in accordance with at least one embodiment described herein. As depicted in FIG. 2, each of the cylindrical multi-piece optical structures 122 includes a solid cylindrical core member 210 and a hollow cylindrical member 220 disposed concentrically about the solid cylindrical core member 210. Each of the plurality of cylindrical multi-piece optical structures 122 may be disposed at the same or different center-to-center distances 270 from one or more neighboring cylindrical optical structures 122. Each of the multi-piece optical structures 122A-122n includes a respective solid cylindrical core member 210A-210n and a respective hollow cylindrical member 220A-220n disposed concentrically about the solid cylindrical core member 210A-210n. Each of the multi-piece optical structures 122 extends a height 280 above the surface 202 of the substrate 130. In embodiments, the multi-piece optical structures 122 may have a height 280 measured from the upper surface 202 of the substrate 130 of about: 0.5 micrometers (μm) or less; 0.7 μm or less; 0.9 μm or less; 1 μm or less; 1.2 μm or less; 1.5 μm or less; or 2.0 μm or less. In embodiments, positioning the hollow cylindrical member 220 concentrically about the solid core member causes a gap 260 to form between the solid cylindrical core member 210 and the surrounding hollow cylindrical member 220.

In embodiments, each of some or all of the plurality of solid cylindrical core members 210A-210n may have the same or different diameters 250. In embodiments, the diameter 250A-250n of each of the solid cylindrical core members 210A-210n may be selected to form a desired gap 260 width between the external surface of the respective solid cylindrical core member 210 and the inner surface of the hollow cylindrical member 260. In embodiments, the solid cylindrical core member 210A-210n may have a diameter 250A-250n of: about 5 nanometers (nm) or less; about 10 nm or less; about 20 nm or less; about 25 nm or less; about 30 nm or less; about 40 nm or less; about 50 nm or less; about 60 nm or less; about 70 nm or less; about 80 nm or less; about 90 nm or less; about 100 nm or less. In embodiments, each of the solid cylindrical core members 250 may be formed using one or more materials such as Titanium Dioxide (TiO₂) or Zirconium Dioxide (ZrO₂).

In embodiments, each of some or all of the plurality of hollow cylindrical members 220A-220n may have the same or different outside diameters 230A-230n and/or the same or different inside diameters 240A-240n to provide a respective wall thickness 242A-242n for each of the multi-piece optical structures 122. In at least some embodiments, each of the multi-piece optical structures 122A-122n may include a hollow cylindrical structure 220A-220n having the same outside diameter 230A-230n and the same inside diameter 240A-240n thereby providing a plurality of hollow cylindrical structures 250A-250n, each having a similar or identical wall thickness 242A-242n. In embodiments, each of the hollow cylindrical structures 220 may have a wall thickness of: about 5 nanometers (nm) or less; about 10 nm or less; about 20 nm or less; about 25 nm or less; about 30 nm or less; about 40 nm or less; about 50 nm or less; about 60 nm or less; about 70 nm or less; about 80 nm or less; about 90 nm or less; about 100 nm or less. In embodiments, each of the hollow cylindrical structures 220 may have a gap 260A-260n of: about 5 nanometers (nm) or less; about 10 nm or less; about 20 nm or less; about 25 nm or less; about 30 nm or less; about 40 nm or less; about 50 nm or less; about 60 nm or less; about 70 nm or less; about 80 nm or less; about 90 nm or less; about 100 nm or less. In embodiments, each of the hollow cylindrical structures 220A-220n may have an outside diameter 230A-230n of: about 40 nm or greater; about 50 nm or greater; about 60 nm or greater; about 70 nm or greater; about 80 nm or greater; about 90 nm or greater; about 100 nm or greater. In embodiments, each of the hollow cylindrical structures 220A-220n may have an inside diameter 240A-240n of: about 30 nm or greater; about 40 nm or greater; about 50 nm or greater; about 60 nm or greater; about 70 nm or greater; about 80 nm or greater; about 90 nm or greater.

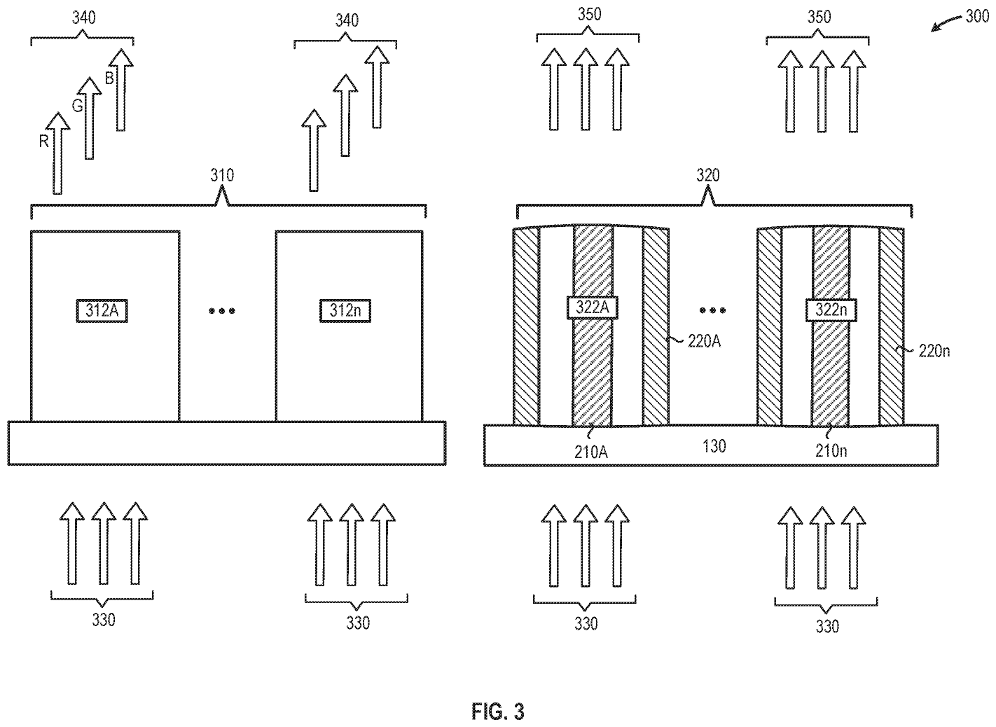

FIG. 3 is a schematic diagram that compares the performance of a first metasurface lens system 310 formed using a plurality of single, uniform, optical structures 312A-312n and a second metasurface lens system 320 in accordance with the apparatuses and systems described herein that is formed using a plurality of multi-component optical structures 322A-322n, in accordance with at least one embodiment described herein. As depicted in FIG. 3, electromagnetic energy in the visible spectrum 340 exiting the uniform optical structures 312A-312n experiences a phase shift (chromatic aberration or dispersion) proportional and/or related to the wavelength of the incident electromagnetic energy 330. Beneficially, the multi-component optical structures 322A-322n maintain the phase relationship and do not cause a phase shift between the incident electromagnetic energy 330 and the electromagnetic energy 350 exiting the second metasurface lens system 320.

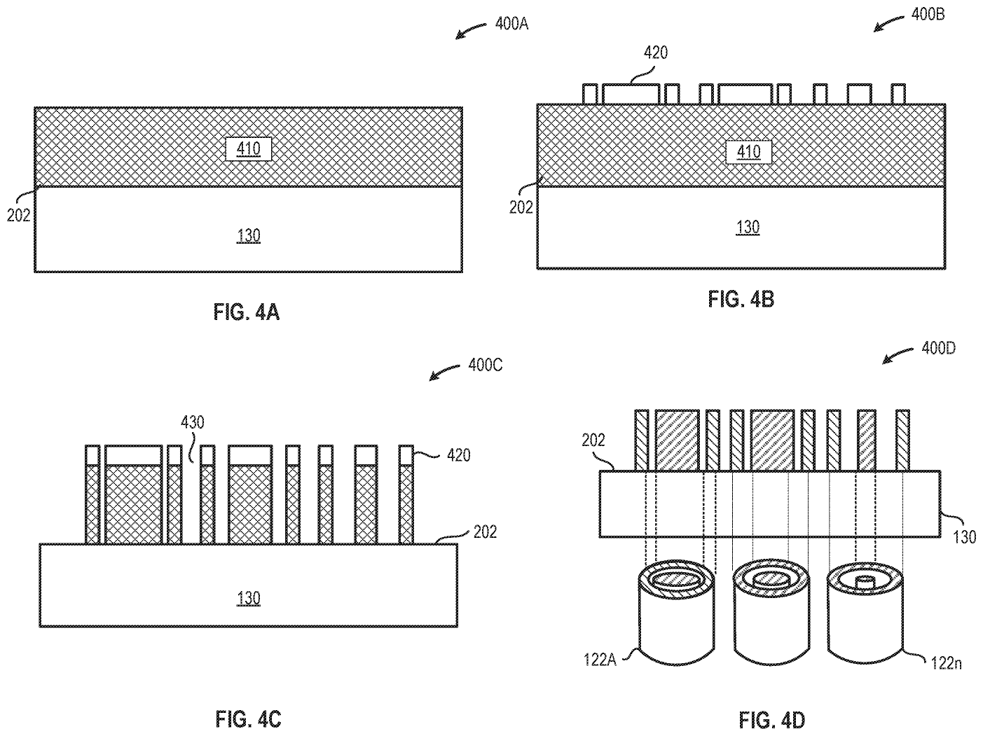

FIGS. 4A, 4B, 4C, and 4D depict an illustrative fabrication method capable of producing a metasurface lens 110 that includes a plurality of multi-element optical structures 122A-122n, in accordance with at least one embodiment described herein. FIG. 4A provides a cross-sectional elevation of a system 400 that includes an illustrative optical structure layer 410 disposed proximate at least a portion of the upper surface of a substrate member 130, in accordance with at least one embodiment described herein. FIG. 4B provides a cross-sectional elevation of the system 400 after deposition of an etch mask 420 on, about, or across at least a portion of the upper surface of the optical structure layer 410, in accordance with at least one embodiment described herein. FIG. 4C provides a cross-sectional elevation of the system 400 after etching to provide voids 430A-430n the optical structure layer 410, in accordance with at least one embodiment described herein. FIG. 4D provides a cross-sectional elevation of the system 400 after removal of the etch mask 420 to provide the plurality of multi-element optical structures 122A-122n disposed across at least a portion of the upper surface of the substrate member 130, in accordance with at least one embodiment described herein.

Referring first to FIG. 4A, an optical structure layer 410 is disposed on, about, or across at least a portion of the upper surface 202 of the substrate member 130. The optical structure layer 410 may include one or more high refractive index materials, such as Titanium Dioxide (TiO₂) or Zirconium Dioxide (ZrO₂). The optical structure layer 410 may have any thickness 280. For example, the optical structure layer 410 may have a thickness 280 of: about 0.5 micrometers (μm) or less; about 0.7 μm or less; about 0.9 μm or less; about 1 μm or less; about 1.2 μm or less; about 1.5 μm or less; or about 2.0 μm or less. The optical structure layer 410 may be deposited using any currently available and/or future developed material deposition process or method. Example material deposition processes include but are not limited to: sputtering, physical vapor deposition, chemical vapor deposition, electroplating, electroless plating, spin coating, or combinations thereof. In embodiments, the substrate member 130 may include one or more materials capable of passing at least a portion of an incident electromagnetic spectrum while producing little, or ideally no, change in the phase relationship between the constituent components of the incident electromagnetic energy. For example, the substrate member 130 may include a Silicon Dioxide (SiO₂) member that is at least partially transparent to at least a portion of the incident visible electromagnetic spectrum and does not affect the phase relationship between the constituent components include in the incident visible electromagnetic spectrum.

Referring next to FIG. 4B, an etch mask 420 is deposited on, about, or across at least a portion of the upper surface of the optical structure layer 410. The etch mask 420 may be deposited using any currently available and/or future developed masking process or method. Example masking processes or methods include, but are not limited to: photolithography, printing, and similar.

Referring next to FIG. 4C, using the etch mask 420, portions of the optical structure layer 410 are selectively removed to form a plurality of voids 430A-430n in the optical structure layer 410. The optical structure layer 410 may be selectively removed using any currently available and/or future developed material removal process or method. Example material removal processes or methods include but are not limited to: wet-etch and dry-etch processes.

Finally, referring to FIG. 4D, the etch mask 420 is removed to expose the multi-element optical structures 122A-122n.

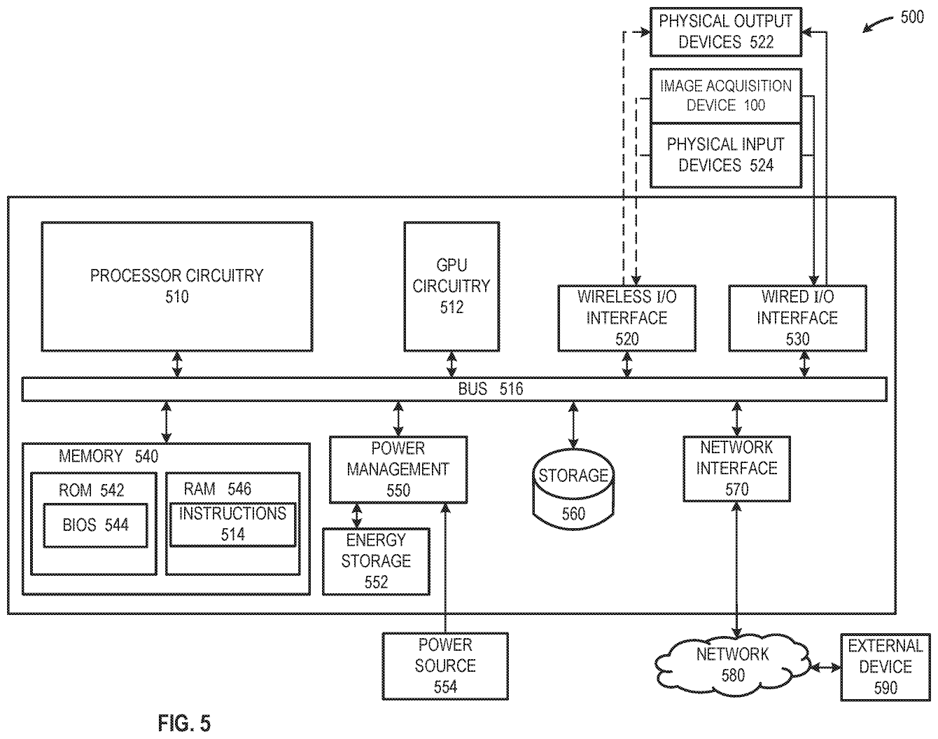

FIG. 5 is a schematic diagram of an illustrative electronic, processor-based, device 600 having one or more physical input devices 524 including a metasurface image acquisition device 100, in accordance with at least one embodiment described herein. The processor-based device 500 may additionally include one or more of the following: processor circuitry 510, processor cache circuitry 512, wireless I/O interface circuitry 520, wired I/O interface circuitry 530, system memory 540, power management circuitry 550, a non-transitory storage device 560, and network interface circuitry 570. The following discussion provides a brief, general description of the components forming the illustrative processor-based device 500. Example, non-limiting processor-based devices 500 may include, but are not limited to: smartphones, wearable computers, portable computing devices, handheld computing devices, desktop computing devices, servers, blade server devices, workstations, and similar.

The processor-based device 500 includes a bus or similar communications link 516 that communicably couples and facilitates the exchange of information and/or data between various system components including the processor circuitry 510, the wireless I/O interface circuitry 520, the wired I/O interface circuitry 530, system memory circuitry 540, one or more non-transitory storage devices 560, and/or the network interface circuitry 570. The processor-based device 500 may be referred to in the singular herein, but this is not intended to limit the embodiments to a single processor-based device 500, since in certain embodiments, there may be more than one processor-based device 500 that incorporates, includes, or contains any number of communicably coupled, collocated, or remote networked circuits or devices.

The processor circuitry 510 may include any number, type, or combination of currently available or future developed devices capable of executing machine-readable instruction sets. The processor circuitry 510 may include but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 516 that interconnects at least some of the components of the processor-based device 500 may employ any currently available or future developed serial or parallel bus structures or architectures.

As depicted in FIG. 5, the system memory circuitry 540 includes read-only memory (“ROM”) circuitry 542 and/or random access memory (“RAM”) circuitry 646. A portion of the ROM circuitry 542 may be used to store or otherwise retain information, data, and/or instruction sets, such as a basic input/output system (“BIOS”) 544. The BIOS 544 provides basic functionality to the processor-based device 500, for example by causing the processor circuitry 510 to load and/or execute one or more machine-readable instruction sets 514. In embodiments, at least some of the one or more machine-readable instruction sets 514 cause at least a portion of the processor circuitry 510 to provide, create, produce, transition, and/or function as a dedicated, specific, and particular machine, for example a word processing machine, a digital image acquisition machine, a media playing machine, a gaming system, a communications device, a smartphone, an autonomous vehicle control system, or similar.

The processor-based device 500 may include wireless input/output (I/O) interface circuitry 520. The wireless I/O interface circuitry 520 may be communicably coupled to one or more physical output devices 522 (tactile devices, video displays, audio output devices, hardcopy output devices, etc.). The at least one wireless I/O interface circuitry 520 may communicably couple to one or more physical input devices 524 (pointing devices, touchscreens, keyboards, tactile devices, etc.), including one or more image acquisition devices 100 that include a multi-structure metasurface lens assembly such as described in detail in FIGS. 1-4, above. The wireless I/O interface circuitry 520 may include any currently available or future developed wireless I/O interface circuitry. Example wireless I/O interfaces circuits 520 include, but are not limited to: BLUETOOTH® communication circuitry, near field communication (NFC) circuitry, and similar local area network (LAN) or personal area network (PAN) circuitry.

The processor-based device 500 may include wired input/output (I/O) circuitry 530. The wired I/O interface circuitry 530 may be communicably coupled to one or more physical output devices 522 (tactile devices, video displays, audio output devices, hardcopy output devices, etc.). The wired I/O interface circuitry 530 may be communicably coupled to one or more physical input devices 524 (pointing devices, touchscreens, keyboards, tactile devices, etc.) including one or more image acquisition devices 100 that include a multi-structure metasurface lens assembly such as described in detail in FIGS. 1-4, above. The wired I/O interface circuitry 530 may include any currently available or future developed I/O interface circuitry. Example wired I/O interfaces circuits 530 include but are not limited to: universal serial bus (USB) circuitry, IEEE 1394 (“FireWire”) circuitry, and similar.

The processor-based device 500 may include one or more communicably coupled, non-transitory, data storage devices 560. The data storage devices 560 may include one or more hard disk drives (HDDs) and/or one or more solid-state storage devices (SSDs). The one or more data storage devices 560 may include any current or future developed storage appliances, network storage devices, and/or systems. Non-limiting examples of such data storage devices 560 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 560 may include one or more removable storage devices, such as one or more flash drives, flash memories, flash storage units, or similar appliances or devices capable of communicable coupling to and decoupling from the processor-based device 500.

The one or more data storage devices 560 may include interfaces or controllers (not shown) communicatively coupling the respective storage device or system to the bus 516. The one or more data storage devices 560 may store, retain, or otherwise contain machine-readable instruction sets, data structures, program modules, data stores, databases, logical structures, and/or other data useful to the processor circuitry 510 and/or one or more applications executed on or by the processor circuitry 510. In some instances, one or more data storage devices 560 may be communicably coupled to the processor circuitry 510, for example via the bus 516 or via the wireless I/O interface circuitry 520 (e.g., Bluetooth®, Near Field Communication or NFC); wired I/O interface circuitry 530 (e.g., Universal Serial Bus or USB); and/or the network interface circuitry 570 (IEEE 802.3 or Ethernet, IEEE 802.11, or WiFi®, etc.).

The processor-based device 500 may include power management circuitry 550 that controls one or more operational aspects of the energy storage device 552. In embodiments, the energy storage device 552 may include one or more primary (i.e., non-rechargeable) or secondary (i.e., rechargeable) batteries or similar energy storage devices. In embodiments, the energy storage device 552 may include one or more supercapacitors or ultracapacitors. In embodiments, the power management circuitry 550 may alter, adjust, or control the flow of energy from an external power supply 554 to the energy storage device 552 and/or to the processor-based device 500. The power source 554 may include, but is not limited to, a solar power system, a commercial electric grid, a portable generator, an external energy storage device, or any combination thereof.

For convenience, the processor circuitry 510, the non-transitory storage device 560, the system memory circuitry 540, the wireless I/O interface circuitry 520, the wired I/O interface circuitry 530, the power management circuitry 550, and the network interface 570 are illustrated as communicatively coupled to each other via the bus 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In some embodiments, all or a portion of the bus 516 may be omitted and the components are coupled directly to each other using suitable wired or wireless connections.

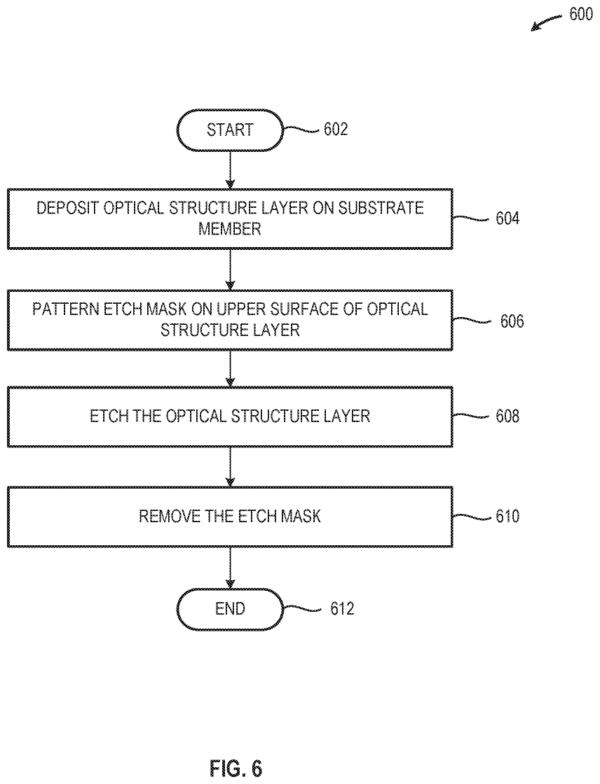

FIG. 6 is a logic flow diagram of an illustrative high-level method 600 for producing a metasurface lens 100 that includes a plurality of multi-component optical structures 122A-122n, in accordance with at least one embodiment described herein. The method 600 beneficially and advantageously provides an optical element or lens that features a thin and lightweight construction and minimal dispersion of the incident electromagnetic energy. The method 600 commences at 602.

At 604, an optical structure layer 410 is disposed on, about, or across at least a portion of the upper surface 202 of the substrate member 130. The optical structure layer 410 may be deposited using any currently available and/or future developed material deposition process or method. Example material deposition processes include but are not limited to: sputtering, physical vapor deposition, chemical vapor deposition, electroplating, electroless plating, spin coating, or combinations thereof.

At 606, an etch mask 420 is patterned or otherwise deposited on, about, or across at least a portion of the upper surface of the optical structure layer 410. The etch mask 420 may be deposited using any currently available and/or future developed masking process or method. Example masking processes or methods include, but are not limited to: photolithography, printing, and similar.

At 608, portions of the optical structure layer 410 are selectively removed to form a plurality of voids 430A-430n in the optical structure layer 410. The optical structure layer 410 may be selectively removed using any currently available and/or future developed material removal process or method. Example material removal processes or methods include but are not limited to: wet-etch and dry-etch processes.

At 610, the etch mask 420 is removed to expose the multi-element optical structures 122A-122n. The method 600 concludes at 612.

While FIG. 6 illustrates various operations according to one or more embodiments, it is to be understood that not all of the operations depicted in FIG. 6 are necessary for other embodiments. Indeed, it is fully contemplated herein that in other embodiments of the present disclosure, the operations depicted in FIG. 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices.

As used in any embodiment herein, the terms “circuit” and “circuitry” may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods useful for providing a metasurface lens formed by a plurality of multi-component optical structures disposed on, about, or across at least a portion of the surface of substrate member. Each of the plurality of multi-component optical structures includes a solid cylindrical core structure surrounded by a hollow cylindrical core structure such that a gap having a defined width forms between the solid cylindrical core structure and the hollow cylindrical structure surrounding the solid core. The width of the gap determines the optical performance of the metasurface lens. The multi-component optical structures forming the metasurface lens advantageously produce little or no phase shift in the electromagnetic energy passing through the metasurface lens, thereby beneficially providing an optical device having minimal or no dispersion and/or chromatic aberration.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for providing a metasurface lens formed by a plurality of multi-component optical structures disposed on, about, or across at least a portion of the surface of substrate member.

According to example 1, there is provided an optical system. The optical system may include: a substrate having a first surface, a thickness, and a second surface disposed transversely across the substrate thickness from the first surface; a plurality of optical structures disposed across at least a portion of the first surface of the substrate, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

Example 2 may include elements of example 1 wherein the core structure may include a solid, cylindrical, core structure; and wherein the hollow structure may include a hollow, cylindrical, structure disposed concentrically about the core structure.

Example 3 may include elements of any of examples 1 or 2 where the core structure comprises a material having a refractive index greater than 2.0.

Example 4 may include elements of any of examples 1 through 3 where the hollow structure comprises a material having a refractive index greater than 2.0.

Example 5 may include elements of any of examples 1 through 4 where the core structure and the hollow structure comprise a material having a refractive index greater than 2.0.

Example 6 may include elements of any of examples 1 through 5 where the core structure and the hollow structure comprise one of: titanium dioxide (TiO₂) or zirconium dioxide (ZrO₂).

Example 7 may include elements of any of examples 1 through 6 where the substrate comprises silicon dioxide (SiO₂).

Example 8 may include elements of any of examples 1 through 7 where the core structure comprises a solid cylindrical core structure having a diameter of less than about 50 nm.

Example 9 may include elements of any of examples 1 through 8 where the hollow structure comprises a hollow cylindrical structure having an inside diameter of about 70 nm.

Example 10 may include elements of any of examples 1 through 9 where the hollow structure comprises a hollow cylindrical structure disposed concentrically about the core structure to provide a gap of from about 5 nm to about 30 nm between an inside surface of the hollow cylindrical structure and the outside surface of the core structure.

According to example 11, there is provided a metasurface optics manufacturing method. The method may include: depositing an optical structure layer having a first thickness across at least a portion of a surface of a substrate layer; patterning an etch mask on the surface of the optical structure layer; and etching the optical structure layer to provide a plurality of optical structures, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

Example 12 may include elements of example 11 where depositing the optical structure layer may include depositing an optical structure layer having a first thickness of from about 5 nanometers (nm) to about 10 micrometers (μm).

Example 13 may include elements of any of examples 11 or 12 where depositing an optical structure layer having a first thickness across at least a portion of a surface of a substrate layer may include: depositing the optical structure layer having the first thickness across at least a portion of the surface of a substrate layer that includes a material at least partially transparent to at least a portion of the visible electromagnetic energy having wavelengths from about 390 nm to about 760 nm.

Example 14 may include elements of any of examples 11 through 13 where etching the optical structure layer to provide the plurality of optical structures may include: etching the optical structure layer to provide a plurality of optical structures in which each of the plurality of optical structures includes: a core structure that includes a solid, cylindrical, core structure having a longitudinal axis of the core structure is disposed perpendicular to the first surface of the substrate; and a hollow structure that includes a hollow, cylindrical, structure disposed concentrically about the core structure and having a longitudinal axis perpendicular to the first surface of the substrate.

Example 15 may include elements of any of examples 11 through 14 where etching the optical structure layer to provide the plurality of optical structures, each of which includes the solid, cylindrical, core structure further includes: etching the optical structure layer to provide the plurality of optical structures, each of which includes a solid, cylindrical, core structure formed using one or more materials having a refractive index of 2.0 or greater.

Example 16 may include elements of any of examples 11 through 15 where etching the optical structure layer to provide the plurality of optical structures, each of which includes the hollow, cylindrical, structure disposed concentrically about the core structure further includes: etching the optical structure layer to provide the plurality of optical structures, each of which includes a hollow, cylindrical, structure formed using one or more materials having a refractive index of 2.0 or greater.

Example 17 may include elements of any of examples 11 through 16 where etching the optical structure layer to provide the plurality of optical structures, each of which includes the solid, cylindrical, core structure and a hollow, cylindrical, structure disposed concentrically about the core structure further comprise: etching the optical structure layer to provide the plurality of optical structures, each of which includes a solid, cylindrical, core structure formed using at least one of: titanium dioxide (TiO₂) or zirconium dioxide (ZrO₂); and etching the optical structure layer to provide the plurality of optical structures, each of which includes a hollow, cylindrical, structure disposed concentrically about the core structure and formed using at least one of: titanium dioxide (TiO₂) or zirconium dioxide (ZrO₂).

Example 18 may include elements of any of examples 11 through 17 where depositing an optical structure layer having a first thickness across at least a portion of a surface of a substrate layer further comprises: depositing an optical structure layer having a first thickness across at least a portion of a surface of a substrate layer that includes silicon dioxide (SiO₂).

Example 19 may include elements of any of examples 11 through 18 where etching the optical structure layer to provide the plurality of optical structures, each of which includes the solid, cylindrical, core structure further comprises: etching the optical structure layer to provide the plurality of optical structures, each of which includes the solid, cylindrical, core structure having a diameter of 100 nanometers or less.

Example 20 may include elements of any of examples 11 through 19 where etching the optical structure layer to provide the plurality of optical structures, each of which includes the hollow, cylindrical, structure disposed concentrically about the core structure further comprises: etching the optical structure layer to provide the plurality of optical structures, each of which includes the hollow, cylindrical, structure having a diameter of 40 nanometers or more disposed concentrically about the core structure.

Example 21 may include elements of any of examples 11 through 20 where etching the optical structure layer to provide the plurality of optical structures, each of which includes the hollow, cylindrical, structure disposed concentrically about the core structure further comprises: etching the optical structure layer to provide the plurality of optical structures, each of which includes the hollow, cylindrical, structure disposed concentrically about the core structure to provide a gap of from about 5 nm to about 50 nm between an inside surface of the hollow cylindrical structure and the outside surface of the core structure.

According to example 22, there is provided a metasurface optics manufacturing system. The system may include: means for depositing an optical structure layer having a first thickness across at least a portion of a surface of a substrate layer; means for patterning an etch mask on the surface of the optical structure layer; and means for etching the optical structure layer to provide a plurality of optical structures, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

Example 23 may include elements of example 22 where the means for depositing the optical structure layer includes: means for depositing an optical structure layer having a first thickness of from about 5 nanometers (nm) to about 10 micrometers (μm).

Example 24 may include elements of any of examples 22 or 23 where the means for depositing an optical structure layer having a first thickness across at least a portion of a surface of a substrate layer includes: means for depositing the optical structure layer having the first thickness across at least a portion of the surface of a substrate layer that includes a material at least partially transparent to at least a portion of the visible electromagnetic energy having wavelengths from about 390 nm to about 760 nm.

Example 25 may include elements of any of examples 22 through 24 where the means for etching the optical structure layer to provide the plurality of optical structures includes: means for etching the optical structure layer to provide a plurality of optical structures in which each of the plurality of optical structures includes: a core structure that includes a solid, cylindrical, core structure having a longitudinal axis of the core structure is disposed perpendicular to the first surface of the substrate; and a hollow structure that includes a hollow, cylindrical, structure disposed concentrically about the core structure and having a longitudinal axis perpendicular to the first surface of the substrate.

Example 26 may include elements of any of examples 22 through 25 where the means for etching the optical structure layer to provide the plurality of optical structures, each of which includes the solid, cylindrical, core structure further comprises: means for etching the optical structure layer to provide the plurality of optical structures, each of which includes a solid, cylindrical, core structure formed using one or more materials having a refractive index of 2.0 or greater.

Example 27 may include elements of any of examples 22 through 26 where the means for etching the optical structure layer to provide the plurality of optical structures, each of which includes the hollow, cylindrical, structure disposed concentrically about the core structure further comprises: means for etching the optical structure layer to provide the plurality of optical structures, each of which includes a hollow, cylindrical, structure formed using one or more materials having a refractive index of 2.0 or greater.

Example 28 may include elements of any of examples 22 through 27 where the means for etching the optical structure layer to provide the plurality of optical structures, each of which includes the solid, cylindrical, core structure and a hollow, cylindrical, structure disposed concentrically about the core structure further comprise: means for etching the optical structure layer to provide the plurality of optical structures, each of which includes a solid, cylindrical, core structure formed using at least one of: titanium dioxide (TiO₂) or zirconium dioxide (ZrO₂); and means for etching the optical structure layer to provide the plurality of optical structures, each of which includes a hollow, cylindrical, structure disposed concentrically about the core structure and formed using at least one of: titanium dioxide (TiO₂) or zirconium dioxide (ZrO₂).

Example 29 may include elements of any of examples 22 through 28 where the means for depositing an optical structure layer having a first thickness across at least a portion of a surface of a substrate layer further comprises: means for depositing an optical structure layer having a first thickness across at least a portion of a surface of a substrate layer that includes silicon dioxide (SiO₂).

Example 30 may include elements of any of examples 22 through 29 where the means for etching the optical structure layer to provide the plurality of optical structures, each of which includes the solid, cylindrical, core structure further comprises: means for etching the optical structure layer to provide the plurality of optical structures, each of which includes the solid, cylindrical, core structure having a diameter of 100 nanometers or less.

Example 31 may include elements of any of examples 22 through 30 where the means for etching the optical structure layer to provide the plurality of optical structures, each of which includes the hollow, cylindrical, structure disposed concentrically about the core structure further comprises: etching the optical structure layer to provide the plurality of optical structures, each of which includes the hollow, cylindrical, structure having a diameter of 40 nanometers or more disposed concentrically about the core structure.

Example 32 may include elements of any of examples 22 through 31 where the means for etching the optical structure layer to provide the plurality of optical structures, each of which includes the hollow, cylindrical, structure disposed concentrically about the core structure further comprises: means for etching the optical structure layer to provide the plurality of optical structures, each of which includes the hollow, cylindrical, structure disposed concentrically about the core structure to provide a gap of from about 5 nm to about 50 nm between an inside surface of the hollow cylindrical structure and the outside surface of the core structure.

According to example 33, there is provided an electronic device. The electronic device may include: processor circuitry; system memory circuitry; one or more I/O device circuits, including: an optical system, that includes: a substrate having a first surface, a thickness, and a second surface disposed transversely across the substrate thickness from the first surface; a plurality of optical structures disposed across at least a portion of the first surface of the substrate, wherein each of the plurality of optical structures includes: a core structure having a longitudinal axis disposed perpendicular to the first surface of the substrate; and a hollow structure disposed at least partially about the core structure, the hollow structure having a longitudinal axis disposed perpendicular to the first surface of the substrate.

Example 34 may include elements of example 33 where the core structure comprises a solid, cylindrical, core structure; and where the hollow structure comprises a hollow, cylindrical, structure disposed concentrically about the core structure.

Example 35 may include elements of any of examples 33 or 34 where the core structure comprises a material having a refractive index greater than 2.0.

Example 36 may include elements of any of examples 33 through 35 where the hollow structure comprises a material having a refractive index greater than 2.0.

Example 37 may include elements of any of examples 33 through 36 where the core structure and the hollow structure comprise a material having a refractive index greater than 2.0.

Example 38 may include elements of any of examples 33 through 37 where the core structure and the hollow structure comprise one of: titanium dioxide (TiO₂) or zirconium dioxide (ZrO₂).

Example 39 may include elements of any of examples 33 through 38 where the substrate comprises silicon dioxide (SiO₂).

Example 40 may include elements of any of examples 33 through 39 where the core structure comprises a solid cylindrical core structure having a diameter of less than about 50 nm.

Example 41 may include elements of any of examples 33 through 40 where the hollow structure comprises a hollow cylindrical structure having an inside diameter of about 70 nm.

Example 42 may include elements of any of examples 33 through 41 where the hollow structure comprises a hollow cylindrical structure disposed concentrically about the core structure to provide a gap of from about 5 nm to about 30 nm between an inside surface of the hollow cylindrical structure and the outside surface of the core structure.

According to example 44, there is provided a dispersion free metasurface optical system, the system being arranged to perform the method of any of examples 11 through 21.

According to example 45, there is provided a chipset arranged to perform the method of any of examples 11 through 21.

According to example 46, there is provided a non-transitory machine readable medium comprising a plurality of instructions that, in response to be being executed on a computing device, cause the computing device to carry out the method according to any of examples 11 through 21.

According to example 47, there is provided a dispersion free metasurface optical system, the device being arranged to perform the method of any of the examples 11 through 21.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed:

1. An optical system, comprising:
a substrate having a first surface, a thickness, and a second surface disposed transversely across the substrate thickness from the first surface;
a plurality of multi-piece optical structures disposed across at least a portion of the first surface of the substrate, wherein each of the plurality of multi-piece optical structures includes:
a core structure having a longitudinal axis disposed perpendicular to the first surface of the substrate; and
a hollow structure disposed at least partially about the core structure, the hollow structure having a longitudinal axis disposed perpendicular to the first surface of the substrate.

2. The system of claim 1:
wherein the core structure comprises a solid, cylindrical, core structure; and
wherein the hollow structure comprises a hollow, cylindrical, structure disposed concentrically about the core structure.

3. The system of claim 1 wherein the core structure comprises a material having a refractive index greater than 2.0.

4. The system of claim 1 wherein the hollow structure comprises a material having a refractive index greater than 2.0.

5. The system of claim 1 wherein the core structure and the hollow structure comprise a material having a refractive index greater than 2.0.

6. The system of claim 5 wherein the core structure and the hollow structure comprise one of: titanium dioxide (TiO₂) or zirconium dioxide (ZrO₂).

7. The system of claim 6 wherein the substrate comprises silicon dioxide (SiO₂).

8. The system of claim 2 wherein the core structure comprises a solid cylindrical core structure having a diameter of less than about 50 nm.

9. The system of claim 9 wherein the hollow structure comprises a hollow cylindrical structure having an inside diameter of about 70 nm.

10. The system of claim 2 wherein the hollow structure comprises a hollow cylindrical structure disposed concentrically about the core structure to provide a gap of from about 5 nm to about 30 nm between an inside surface of the hollow cylindrical structure and the outside surface of the core structure.

11. A metasurface optics manufacturing method, comprising:
depositing an optical structure layer having a first thickness across at least a portion of a surface of a substrate layer;
patterning an etch mask on the surface of the optical structure layer; and
etching the optical structure layer to provide a plurality of multi-piece optical structures, wherein each of the plurality of multi-piece optical structures includes:
a core structure having a longitudinal axis disposed perpendicular to the first surface of the substrate; and
a hollow structure disposed at least partially about the core structure, the hollow structure having a longitudinal axis disposed perpendicular to the first surface of the substrate.

12. The method of claim 11 wherein depositing the optical structure layer comprises depositing an optical structure layer having a first thickness of from about 5 nanometers (nm) to about 10 micrometers (μm).

13. The method of claim 12 wherein depositing an optical structure layer having a first thickness across at least a portion of a surface of a substrate layer comprises:
depositing the optical structure layer having the first thickness across at least a portion of the surface of a substrate layer that includes a material at least partially transparent to at least a portion of the visible electromagnetic energy having wavelengths from about 390 nm to about 760 nm.

14. The method of claim 12 wherein etching the optical structure layer to provide the plurality of multi-piece optical structures includes:
etching the optical structure layer to provide a plurality of optical structures in which each of the plurality of optical structures includes:
a core structure that includes a solid, cylindrical, core structure having a longitudinal axis of the core structure is disposed perpendicular to the first surface of the substrate; and
a hollow structure that includes a hollow, cylindrical, structure disposed concentrically about the core structure and having a longitudinal axis perpendicular to the first surface of the substrate.

15. The method of claim 14 wherein etching the optical structure layer to provide the plurality of multi-piece optical structures, each of which includes the solid, cylindrical, core structure further comprises:
etching the optical structure layer to provide the plurality of multi-piece optical structures, each of which includes a solid, cylindrical, core structure formed using one or more materials having a refractive index of 2.0 or greater.

16. The method of claim 15 wherein etching the optical structure layer to provide the plurality of multi-piece optical structures, each of which includes the hollow, cylindrical, structure disposed concentrically about the core structure further comprises:
etching the optical structure layer to provide the plurality of multi-piece optical structures, each of which includes a hollow, cylindrical, structure formed using one or more materials having a refractive index of 2.0 or greater.

17. The method of claim 14 wherein etching the optical structure layer to provide the plurality of multi-piece optical structures, each of which includes the solid, cylindrical, core structure and a hollow, cylindrical, structure disposed concentrically about the core structure further comprise:
etching the optical structure layer to provide the plurality of multi-piece optical structures, each of which includes a solid, cylindrical, core structure formed using at least one of:
titanium dioxide (TiO₂) or zirconium dioxide (ZrO₂); and
etching the optical structure layer to provide the plurality of multi-piece optical structures, each of which includes a hollow, cylindrical, structure disposed concentrically about the core structure and formed using at least one of: titanium dioxide (TiO₂) or zirconium dioxide (ZrO₂).

18. The method of claim 11 wherein depositing an optical structure layer having a first thickness across at least a portion of a surface of a substrate layer further comprises:
depositing an optical structure layer having a first thickness across at least a portion of a surface of a substrate layer that includes silicon dioxide (SiO₂).

19. The method of claim 14 wherein etching the optical structure layer to provide the plurality of multi-piece optical structures, each of which includes the solid, cylindrical, core structure further comprises:
etching the optical structure layer to provide the plurality of multi-piece optical structures, each of which includes the solid, cylindrical, core structure having a diameter of 100 nanometers or less.

20. The method of claim 19 wherein etching the optical structure layer to provide the plurality of multi-piece optical structures, each of which includes the hollow, cylindrical, structure disposed concentrically about the core structure further comprises:
etching the optical structure layer to provide the plurality of multi-piece optical structures, each of which includes the hollow, cylindrical, structure having a diameter of 40 nanometers or more disposed concentrically about the core structure.

21. The method of claim 14 wherein etching the optical structure layer to provide the plurality of multi-piece optical structures, each of which includes the hollow, cylindrical, structure disposed concentrically about the core structure further comprises:
etching the optical structure layer to provide the plurality of multi-piece optical structures, each of which includes the hollow, cylindrical, structure disposed concentrically about the core structure to provide a gap of from about 5 nm to about 50 nm between an inside surface of the hollow cylindrical structure and the outside surface of the core structure.

22. A metasurface optics manufacturing system, comprising:
means for depositing an optical structure layer having a first thickness across at least a portion of a surface of a substrate layer;
means for patterning an etch mask on the surface of the optical structure layer; and
means for etching the optical structure layer to provide a plurality of multi-piece optical structures, wherein each of the plurality of multi-piece optical structures includes:
a core structure having a longitudinal axis disposed perpendicular to the first surface of the substrate; and
a hollow structure disposed at least partially about the core structure, the hollow structure having a longitudinal axis disposed perpendicular to the first surface of the substrate.

23. The system of claim 22 wherein the means for depositing the optical structure layer comprises:
means for depositing an optical structure layer having a first thickness of from about 5 nanometers (nm) to about 10 micrometers (μm).

24. The system of claim 23 wherein the means for depositing an optical structure layer having a first thickness across at least a portion of a surface of a substrate layer comprises:
means for depositing the optical structure layer having the first thickness across at least a portion of the surface of a substrate layer that includes a material at least partially transparent to at least a portion of the visible electromagnetic energy having wavelengths from about 390 nm to about 760 nm.

25. The system of claim 23 wherein the means for etching the optical structure layer to provide the plurality of multi-piece optical structures includes:
means for etching the optical structure layer to provide a plurality of multi-piece optical structures in which each of the plurality of multi-piece optical structures includes:
a core structure that includes a solid, cylindrical, core structure having a longitudinal axis of the core structure is disposed perpendicular to the first surface of the substrate; and
a hollow structure that includes a hollow, cylindrical, structure disposed concentrically about the core structure and having a longitudinal axis perpendicular to the first surface of the substrate.
